(19) United States
(12) Patent Application Publication
(10) Pub. No.: US 2008/0262891 A1
(43) Pub. Date: Oct. 23, 2008

(54) POLICY BASED DISTRIBUTION MODELING VIA INFORMATION MODELS

(75) Inventors: Ramprasadh Kothandaraman, Bangalore (IN); Ankur Bhatt, Bangalore (IN); Hans-Martin Ludwig, Wiesloch (DE); Venkat Srinivas Seshasai, Chennai (IN)

Correspondence Address: KENYON & KENYON LLP, 1500 K STREET N.W., SUITE 700, WASHINGTON, DC, 20005, US

(73) Assignee: SAP AG, Walldorf (DE)

(21) Appl. No.: 11/737,902

(22) Filed: Apr. 20, 2007

(51) Int. Cl. G06F 9/46

(52) U.S. Cl. 705/8

(57) ABSTRACT

The method by which an information distribution system distributes information to subscribers is controlled by user profiles. A user profile is automatically generated by a profile generator based on information known about the user and a plurality of policies detailing what kind of users is eligible to receive what kind of information. User information and policy definitions are found on a user record store and a policy store connected to the profile generator, and the generated user profile is stored on a user profile store.

### BACKGROUND

The present invention relates to information distribution systems that automatically generate customized profiles based on defined policies.

Information distribution is needed in various scenarios to facilitate business operations. Typically, information is gathered from a plurality of sources, such as user and product databases, and sent to a number of devices, such as computer terminals and PDAs, connected to the distribution system. As the amount of information available to the system grows, transferring the information in its entirety becomes increasingly burdensome. In addition, making all the information available to every device not only would hinder its user's ability to quickly locate the information that is needed to carry out his or her responsibilities, but also would place unnecessarily high requirements on the storage capacity and connection bandwidth of the receiving device.

The information needed by each user can be influenced by a range of factors, such as his or her job function, permission level, scope of operation, etc. A distribution system adapted to distribute only information that is relevant to each of its users is both more efficient and practicable than the ones that transmit everything without discrimination. However, an inevitable side effect of this is that the information needed for each user can vary tremendously from one to another, and distribution systems must keep track of the differences.

Current distribution systems accommodate targeted information distribution by using user profiles. A profile tells a distribution system what information should be supplied to the user associated with it. When the user makes an request for information, the distribution system would read through the user's profile, retrieve the subset of information detailed by the profile, and send the subset to the device from which the user made the request.

An exemplary implementation of the above mentioned prior art is illustrated by FIG. 1. The distribution system includes a distribution engine 110, a database backend 120, a network 130, a plurality of terminal devices 140, a user profile store 150, a plurality of administrators 160, and a plurality of specialized scripts 170.

The distribution engine 110 extracts data from the database backend 120 to fulfill information requests made by the terminal devices 140. The terminal devices 140 are connected to the distribution engine 110 via a communication network 130. The distribution engine 110 distributes the data according to user profiles found on a provided user profile store 150. The administrators 160 interacts with the user profile store 150 to add, delete or modify user profiles by either manual actions or scripts 170 that are specifically aimed to generate profiles for defined user groups. In setting up an user profile, an administrator 160 can use a checklist and/or other references to decide the proper settings for the instant user.

Information distribution occurs when a terminal device 140 requests data from the distribution engine 110 via a communication network 130. In response, the distribution engine 110 refers to the user profile store 150 to validate the terminal device and determine whether the device user should receive any information. If so, the distribution engine 110 collects relevant information and returns it to the device 140. User profiles within the store 150 typically identify what kind of information from the database system 120 each user has access rights to, which may be requested directly or through a subscription.

Although the system of FIG. 1 permits information distribution, several new difficulties, especially within the categories of scalability and maintainability, arise with the adoption of user profiles. Profiles are created by administrators on a per-subscriber basis. Each profile requires a range of information to be inputted. When creating profiles for a homogeneous group of users, such as users from the same department or of the same responsibilities, template profiles are often created to facilitate this process. Even so, administrators usually still have to fill in many details before each profile can be released into operation. As the number of subscribers grows, for example, to include all subscribers in a large enterprise system (say, 1000 users or more) the manual maintenance of an information distribution network becomes problematic.

In addition, businesses often change their distribution policies, which require corresponding changes possibly to every user profile in the enterprise. Manual updates to profiles and specifically coded scripts are the commonly adopted solutions. For manual updates, administrators would need to edit the profiles one-by-one and make individualized changes to each. Alternatively, scripts-based solutions are useful for practical purposes only when a single change extends to all users within an enterprise. Neither of these solutions provide sophisticated distribution policies to be implemented.

Accordingly, there is a need in the art for a system that can automatically create and maintain profiles customized to each user without undue needs for administrative involvement, such as manual updates and specialized scripts.

### BRIEF DESCRIPTION OF THE DRAWINGS

FIG. 1 shows a typical interaction scheme between components of an information distribution system using known techniques to create and maintain user profiles.

FIG. 2 illustrates an exemplary interaction scheme between components of the system of present invention.

FIG. 3 is a walkthrough of one possible embodiment of the present invention operating on a sample dataset.

FIG. 4 demonstrates the operation flow of an exemplary user-based implementation of the present invention.

FIG. 5 demonstrates the operation flow of an exemplary policy-based implementation of the present invention.

FIG. 6 illustrates a method according to an embodiment of the present invention.

FIG. 7 illustrates a method according to another embodiment of the present invention.

### DETAILED DESCRIPTION

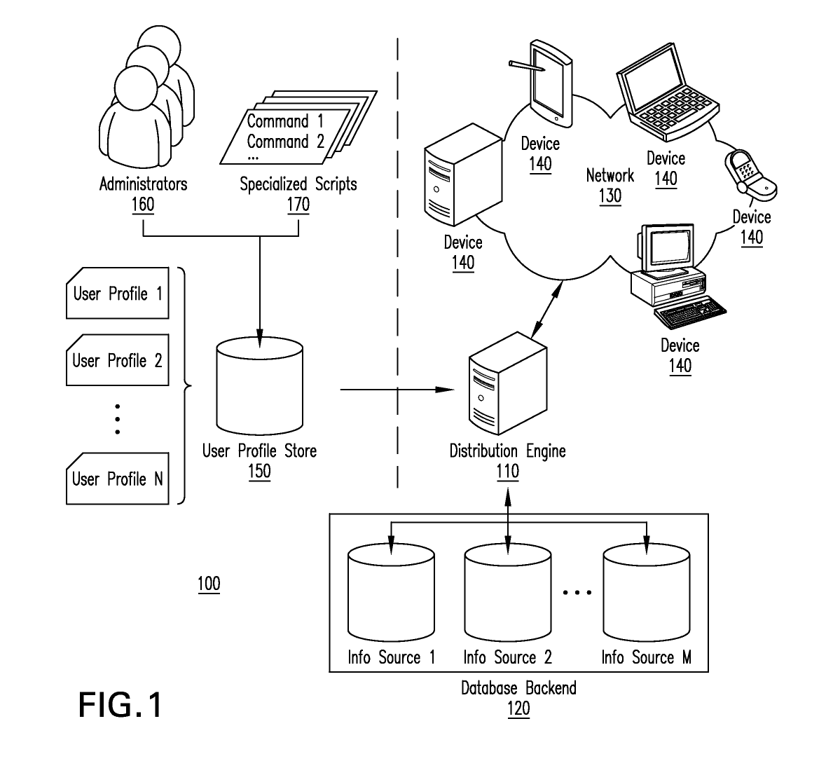

Embodiments of the present invention provide a means for information distribution system administrators to efficiently create and maintain user profiles which are used to control the fashion under which information is distributed to each user. Administrators create distribution policies, which define general frameworks for distribution of information from among massive datasets provided by backend databases. A profile generator reads user data records and applies various ones of the distribution policies to them to create a user profile. The user profile may be used by a distribution system, such as the runtime distribution system of FIG. 1, to handle data requests from terminal devices. In this regard, the present invention may be used to generate large sets of user profiles in a convenient, policy-driven manner.

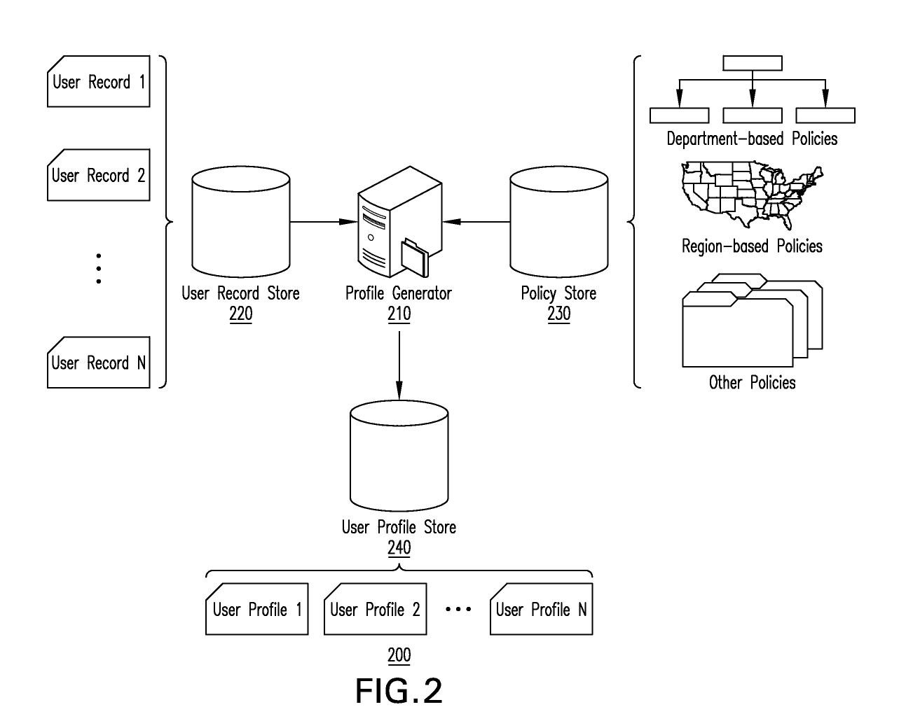

FIG. 2 illustrates a functional block diagram of profile generation system 200 according to an embodiment of the present invention. The system 200 may consist of a profile generator 210, a user record store 220, a policy store 230, and a user profile store 240.

Profile generator 210 may create user profiles automatically for a selected number of user records stored by the user record store 220. The Profile generator 210 may evaluate each record against an array of applicable policies stored by the policy store 230. The tailored profile for each record is then created using the results of the conducted evaluations for that record and saved onto the user profile store 240.

The user record store 220 could be a database, a hierarchical or flat file, or other storage system to store data representing users of the distribution system. Each record may contain one or more fields and the layout of such fields is referenced as the record's “signature.” For example, a set of records capturing information about an employee may have a signature such as {employee ID, department, region, title, start date, supervisor ID}. Although FIG. 2 shows a user record store 220, the record store could be used to maintain a variety of entity units, such as classes of users, individual devices, or classes of devices.

Policy store 230 could be a database, a hierarchical or flat file, or other storage system to contain necessary policy definitions. Each definition typically contains three sections: policy signature, value enumeration, and mapping. However, other suitable implementations may contain more or less sections. Each policy operates on a set of fields captured in the user record store 220. The list of a policy's required fields is referenced as the policy's “signature.” Using the previous employee record signature example, a policy operating on the locations and specialties of the employees may have a signature such as {department, region}. For each field in the policy signature, there is a list of possible values. If only one field is found in the signature, the enumeration is simply the list; otherwise, it is a list of all possible combinations. For example, if the field department can contain either Sales or Marketing, and the field region either TX or DC, then the enumeration list would be {Sales, TX}, {Sales, DC}, {Marketing, TX}, and {Marketing, DC}. The list does not have to be a full enumeration. Furthermore, it may contain special fields capturing conditions such as default (when the value in the record does not match one of the enumerated values in a partial enumeration list) and null (when at least one of the required fields in the re-cord is empty). Each enumerated value combination is mapped to a set of data. Each set reflects the information that should be distributed to the user if the user's record matches the specific enumeration entry. For example, if {Sales, DC} is mapped to East Coast Annual Sales Figures and Commercial Regulations, then any user who works in the DC sales department should receive those information.

User profile store 240 could be a database, a hierarchical or flat file, or any other viable means to store profiles. Each profile contains, along with other necessary information, entries of subscriptions as defined by applicable policies which will instruct the distribution engine 110 of what information to collect and send for the user.

In one embodiment, the profile generator 210 may access the user record store 220 and read the stored user records individually. For each read user record, the profile generator 210 evaluates the information within the record against all applicable policies found on the policy store 230. For each policy, if the user qualifies for one or more sets of data, then the corresponding mapping is captured in a separate file, which becomes the user's profile that gets stored on the user profile store 240 when the profile generator 210 cycles through all policies.

In another embodiment, the profile generator 210 accesses the policy store 230 and reads each policy individually. Then for each read policy, the profile generator 210 locates all affected user records found on the user record store 220 and conducts the evaluation as mentioned prior. A set of temporary user profiles is created for each user record. The set stays in temporary status until each policy and each user record have been fully processed. At that point, the set becomes ready for use by the distribution engine 110 and saved onto the user profile store 240.

The profile generation process could be initiated by administrators 160 when a new user is to be added to the information distribution system or changes have been made which necessitate updates to existing profiles. Alternatively, the process could be triggered automatically. For example, in one embodiment, the profile generator 210 is notified of changes on the policy store 230 or polls the store 230 to identify changes. When a policy has been changed, the profile generator 210 may locate user records that could be affected by this change in the user record store 220, and may regenerate their corresponding user profiles and replace the existing ones on the user profile store 240. In other embodiments, the profile generator 210 can listen to the user record store 220 or both the user record store 220 and the policy store 230 for changes and act accordingly. Changes that the profile generator 210 could listen to include addition, modification, and deletion actions within the stores. Another approach the profile generator 210 might take is to periodically regenerate a subset or all of the user profiles. This could be done daily, weekly, or which ever frequency that the administrators 160 deem suitable. Furthermore, the profile generator 210 can also listen to other external events that may trigger the generation process. For example, an information distribution system adapted for parcel delivery trucks might want its profile generator 210 to regenerate some or all of its user profiles several days before every holiday rush hits.

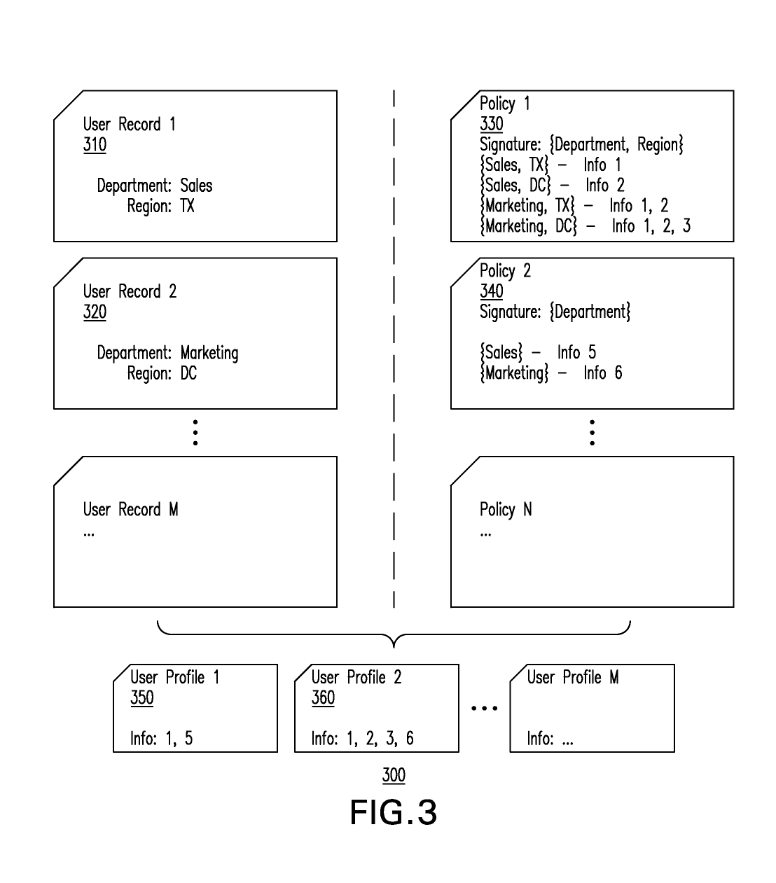

FIG. 3 illustrates exemplary dataset for use with the foregoing embodiments of the present invention. As illustrated, the dataset includes user records, 1 . . . M, and distribution policies 1 . . . N. User profiles 1 . . . M are generated from the user records and distribution policies.

In the example, policy 1 (330) has the signature {Department, Region} and contains a full enumeration list. When the profile generator 210 evaluates user record 1 (310) against policy 1, it may find the combination {Sales, TX} to have mapped to Info 1. Similarly, when evaluated against policy 2 (340) the profile generator 210 may identify a mapping to Info 5. Combining the results together, the profile generator 210 may generate a tailored user profile 1, (350) for user record 1 (310) with information elements 1 and 5 as its information subscription entries;

Each enumeration can be mapped to more than one subscription. Here, user record 2 (320) maps to Info 1, 2, and 3 under policy 1 (330), which is represented in the resulting user profile 2 (360). If one subscription has been entered into a profile more than once, the profile generator 210 may either eliminate or keep the duplicated entry, depending on the implementation.

In another embodiment, the profiles might not have a signature and the profile generator 210 would parse through each policy and extract the data fields that are needed by the policy. These data fields may or may not have the same roles as the policy signatures mentioned above. Not every data field needs to serve as an identifier to locate the appropriate the data mappings. Alternatively, some data fields may be used as input parameters to drive data generation. For example, department might be used to identify which information source to pull the data from. So if the value is Sales, then the user could be mapped to receive information pertaining to sales figures. At the same time, region might be used to drive data generation during data distribution. If the user's region is TX, then the distribution engine 110 could send it to the database backend 120, and the sales database would only pull sales information that is specifically for TX.

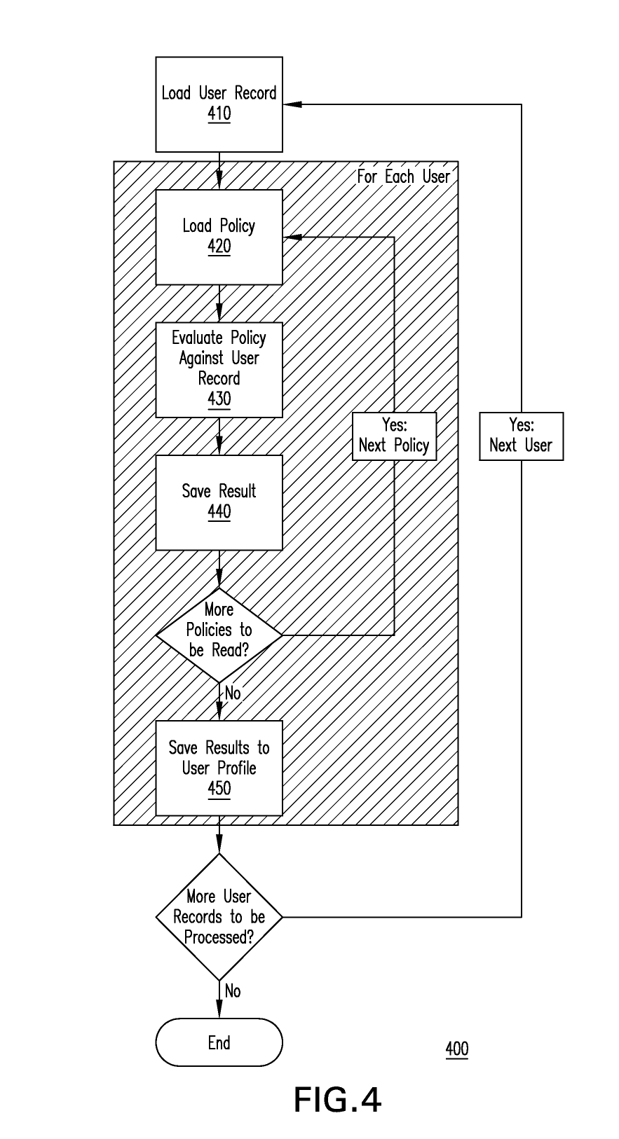

FIG. 4 is a flow diagram of a method according to an embodiment of the present invention. The method 400 may load a user record 410 and load policy 420, evaluate policy against user record 430, save result 440, and save results to user profile 450. Load user record 410 involves the profile generator 210 reading a record from user record store 220 into memory. For load policy 420, the profile generator 210 reads a policy record from policy store 230 into memory. Evaluate policy against user record 430 entails checking to see if the user record would qualify for any information mapping under the instant policy, as explained in FIG. 3. Save result 440 saves the result from the current evaluation 430 to memory, and save results to user profile 450 happens when all evaluations have been conducted for this particular user and the user profile is ready to be constructed from all the results.

To create user profiles for a set of user records, the profile generator 210 loads a user record 410 from user record store 220 into memory by reading the user information. Then for this user record, the profile generator 210 processes every policy relevant to the user before moving on to the next one. So after loading the user record 410, the profile generator 210 loads the first policy record 420 from policy store 230. In one embodiment, the generator extracts the policy signature with or without fully reading the policy itself. The policy signature is then compared to the user record as a part of the evaluation 430. Comparison may consist checking to see if this policy is applicable to the instant user. For example, it is applicable if the information contained within the user record includes the data needed for each of the field in the policy signature. For an applicable policy, the profile generator 210 continues the evaluation process 430 by determining if the user qualifies for any of the data mappings detailed within the policy. If such a mapping exists, then the profile generator 210 records its findings by saving all the mapping results from this policy into memory 440. If the instant policy is not the last one on the policy store 230, the profile generator 210 moves on to the next policy record and repeat this process until all records have been processed against the instant user record. After cycling through each policy, all the mapping results from all the policies are processed to generate the user profile 450 for this user. In one embodiment, creating the user profile would entail simply saving all the results to a text file. In another embodiment, the profile generator 210 may have to put the mapping information in a certain format, such as XML. Once saved, this user record is considered to be fully processed. The profile generator 210 may move on to the next user record if there are more records and repeat the entire process until all users are fully processed.

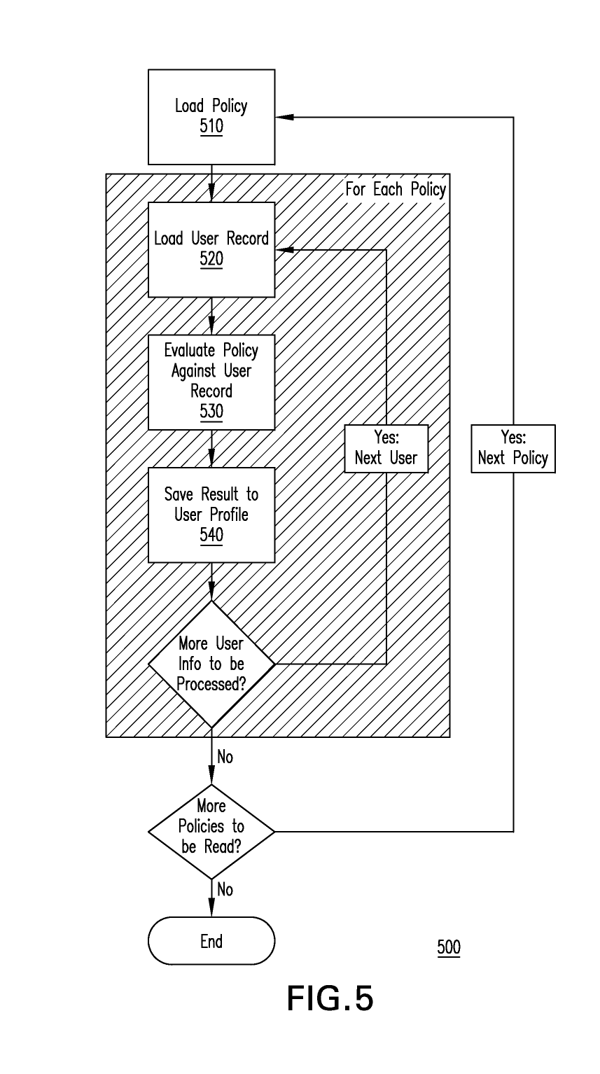

FIG. 5 demonstrates the operation flow of an exemplary policy-based implementation of the present invention. This implementation is called “policy-based” because it processes each user record incrementally before moving on to the next record. As a result, the created user profiles are not fully operational until every policy has been evaluated. The operation flow may consist of load policy 510, load user record 520, evaluate policy against user record 530, and save result to user profile 540. For load policy 510, the profile generator 210 reads a policy record from policy store 230 into memory. Load user record 520 involves the profile generator 210 reading a record from user record store 220 into memory. Evaluate policy against user record 530 entails checking to see if the user record would qualify for any information mapping under the instant policy, as explained in FIG. 3. Save result to user profile 540 saves the result from the current evaluation 430 to the user profile that corresponds to the instant user.

To create user profiles for a set of user records, the profile generator 210 loads a policy record 510 from policy store 230 into memory. In one embodiment, the generator extracts the policy signature with or without fully reading the policy itself. Then for this policy record, the profile generator 210 processes every user record for which this policy is relevant to before moving on to the next one. So after loading the policy record 510, the profile generator 210 loads the first user record 520 from the user record store 220 into memory by reading the user information. The policy signature is then compared to the user record as a part of the evaluation 530. Comparison may consist checking to see if this user is affected by the instant policy. For example, it is affected if the information contained within the user record includes the data needed for each of the field in the policy signature. For an affected user, the profile generator 210 continues the evaluation process 530 by determining if the user qualifies for any of the data mappings detailed within the policy. If such a mapping exists, then the profile generator 210 records its findings by appending and saving all the mapping results from this policy to the user's user profile 540. Depending on the implementation, the partially completed user profile could be kept in memory, maintained as a file, or any other suitable way. In one embodiment, creating the user profile would entail simply saving all the results to a text file. In another embodiment, the profile generator 210 may have to put the mapping information in a certain format, such as XML. If the instant user record is not the last one on the user record store 220, the profile generator 210 moves on to the next user record and repeat this process until all records have been processed against the instant policy. After cycling through each user, this policy record is considered to be fully processed. The profile generator 210 may move on to the next policy record if there are more records and repeat the entire process until all policies are fully processed.

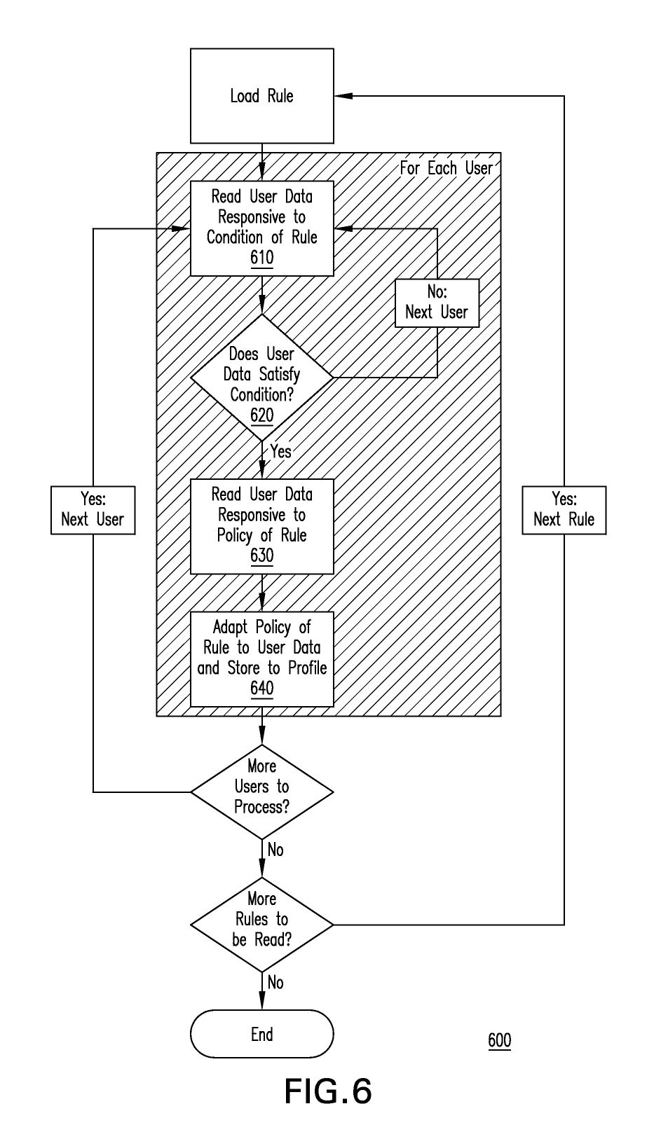

FIG. 6 illustrates another method 600 according to an embodiment of the present invention. In this embodiment, the method 600 auto-discovers which fields of user data are relevant to the system's distribution policies. Accordingly, the method operates iteratively over each instance of user data and over each rule defining a distribution policy. Given a condition of a distribution rule, the method reads fields from the user data that are relevant to the rule's condition definition and determines whether the user data satisfies the condition of the respective rule (boxes 610, 620). If so, the method identifies fields that define the corresponding distribution policy and reads corresponding fields from the user data (box 630). The method adapts the policy to the user data and stores the adapted distribution policy to a user profile (box 640). Thereafter, the method may return to box 610 to consider a new user. Of course, if at box 620, the condition was not satisfied, the method may advance to the next user automatically. In this embodiment, there are two reads from user data—a first read to determine whether a distribution policy applies and a second read to adapt the policy to the user data. Different fields of user data may govern in the two reads.

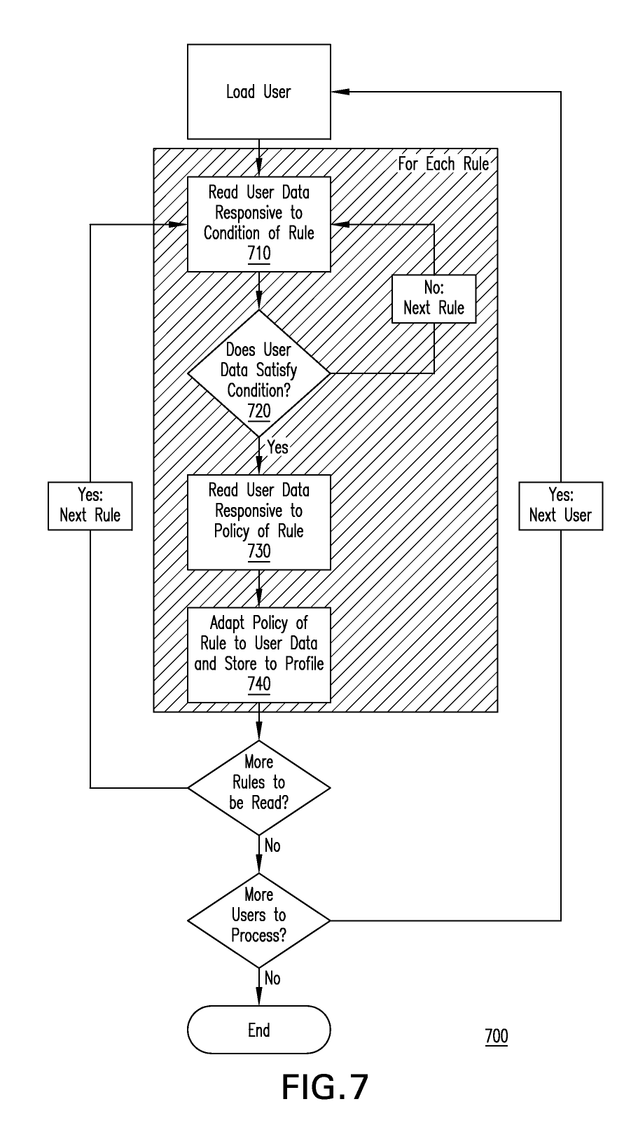

FIG. 7 illustrates a further method 700 according to another embodiment. In this embodiment, the method 700 also auto-discovers fields that are relevant to the distribution policies but the method operates on a user-by-user basis as opposed to a rule-by-rule basis. The method considers each rule and identifies which fields of user data are relevant to the condition of the user policy. The method reads fields from the user data that are relevant to the rule's condition definition and determines whether the user data satisfies the condition of the respective rule (boxes 710, 720). If so, the method identifies fields that define the corresponding distribution policy and reads corresponding fields from the user data (box 730). The method adapts the policy to the user data and stores the adapted distribution policy to a user profile (box 740). Thereafter, the method may return to box 710 to consider a new rule. Of course, if at box 720, the condition was not satisfied, the method may advance to the next rule automatically. In this embodiment, there are two reads from user data—a first read to determine whether a distribution policy applies and a second read to adapt the policy to the user data. Different fields of user data may govern in the two reads.

Several embodiments of the invention are specifically illustrated and/or described herein. However, it will be appreciated that modifications and variations of the invention are covered by the above teachings and within the purview of the appended claims without departing from the spirit and intended scope of the invention.

We claim:

1. A method for creating a user profile, comprising:
loading a user record comprising a set of user values describing a user;
loading a policy record comprising a set of mappings, each mapping associating at least one user value to at least one information source;
creating the user profile with default user values and associating the user profile with the user record;
determining if the policy record is applicable to the user record; and
if the policy record is applicable:
extracting a set of information sources from the mappings of the policy record; and
amending the user profile to reflect the set of information sources.

2. The method of claim 1, wherein determining applicability comprises:
reading from the policy record a set of requirements for applicability; and
evaluating the set of requirements against the user record.

3. The method of claim 2, wherein the policy record comprises a section outlining the set of requirements.

4. The method of claim 2, wherein reading a set of requirements comprises:
for each mapping in the policy record:
extracting the user value associated with the mapping; and
storing the extracted user values in a set.

5. The method of claim 2, wherein the set of requirements comprises a set of discrete user values.

6. The method of claim 2, wherein the set of requirements comprises a set of user value ranges.

7. The method of claim 1, wherein the policy record is partially applicable to the user record.

8. The method of claim 1, wherein extracting a set of information sources comprises, for each mapping within the policy record:
determining if the mapping is applicable to the user record;
if so, extracting the information source associated with the mapping; and
storing the extracted information sources in a set.

9. The method of claim 1, wherein extracting a set of information sources comprises:
for each mapping in the policy record:
extracting the information sources associated with the mapping; and
storing the extracted information sources in a set.

10. The method of claim 1, wherein the set of information sources comprises only unique entries of information sources.

11. The method of claim 1, wherein the set of information sources comprises only information sources that the user can be mapped to.

12. The method of claim 1, wherein amending the user profile comprises:
creating a temporary user profile using the set of information sources; and
replacing the user profile comprising the default user values with the temporary user profile.

13. The method of claim 1, wherein reflecting the set of information sources comprises adding the set of information sources.

14. The method of claim 1, wherein reflecting the set of information sources comprises adding only information sources from the set of information sources that are not already present in the user profile.

15. The method of claim 1, wherein reflecting the set of information sources comprises replacing an existing set of information sources with the set of information sources.

16. The method of claim 1, wherein reflecting the set of information sources comprises removing a set of existing information sources that are inconsistent with the set of information sources.

17. A method for creating a user profile, comprising:
loading a user record comprising a set of user values describing a user;
loading a set of policy records, each policy record comprising a set of mappings, each mapping associating at least one user value to at least one information source;
creating the user profile with default user values and associating the user profile with the user record;
for each policy record:
determining if the policy record is applicable to the user record;
if the policy record is applicable:
extracting a set of information sources from the mappings of the policy record; and
amending the user profile to reflect the set of information sources.

18. A method for creating a set of user profiles, comprising:
loading a set of user records, each user record comprising a set of user values describing a user;
loading a policy record comprising a set of mappings, each mapping associating at least one user value to at least one information source;
for each user record:
creating a user profile with default user values and associating the user profile with the user record;
determining if the policy record is applicable to the user record;
if the policy record is applicable:
extracting a set of information sources from the mappings of the policy record; and
amending the user profile to reflect the set of information sources.

19. A method for creating a set of user profiles, comprising:
loading a set of user records, each user record comprising a set of user values describing a user;
loading a set of policy records, each policy record comprising a set of mappings, each mapping associating at least one user value to at least one information source;
for each user record:
creating a user profile with default user values and associating the user profile with the user record;
for each user record and each policy record:
determining if the policy record is applicable to the user record;
if the policy record is applicable:
extracting a set of information sources from the mappings of the policy record; and
amending the user profile to reflect the set of information sources.

20. A method for creating a user profile using a profile generator, comprising:
specifying a user record comprising a set of user values describing a user;
specifying a policy record comprising a set of mappings, each mapping associating at least one user value to at least one information source; and
executing the profile generator;
wherein the profile generator is adapted to create the user profile by:
loading the user record;
loading the policy record;
creating the user profile with default user values and associating the user profile with the user record;
determining if the policy record is applicable to the user record;
if the policy record is applicable:
extracting a set of information sources from the mappings of the policy record; and
amending the user profile to reflect the set of information sources;

21. The method of claim 20, wherein the method is executed in response to an update of a user record.

22. The method of claim 20, wherein the method is executed in response to an update of a policy record.

23. The system of claim 20, wherein the method is executed by manual input.

24. The system of claim 20, wherein the method is executed automatically.

25. A system adapted to create a user profile, comprising:
a profile generator;
a user record store;
a policy record store; and
a user profile store;
wherein the profile generator is adapted to generate the user profile by:
loading a user record from the user record store, the user record comprising a set of user values describing a user;
loading a policy record from the policy store, the policy record comprising a set of mappings, each mapping associating at least one user value to at least one information source;
creating the user profile with default user values and associating the user profile with the user record;
determining if the policy record is applicable to the user record; and
if the policy record is applicable:
extracting a set of information sources from the mappings of the policy record; and
amending the user profile to reflect the set of information sources.

26. The system of claim 25, wherein at least two members of the group consisting of the profile generator, the user record store, the policy record store and the user profile store are connected by a network.

27. The system of claim 25, wherein at least two members of the group consisting of the profile generator, the user record store, the policy record store and the user profile store reside on a same computer system.

28. A computer readable medium having program instructions stored thereon that, when executed, causes a computer system to:
load a user record comprising a set of user values describing a user;
load a policy record comprising a set of mappings, each mapping associating at least one user value to at least one information source;
create a user profile with default user values and associating the user profile with the user record;
determine if the policy record is applicable to the user record; and
if the policy record is applicable:
extract a set of information sources from the mappings of the policy record; and
amend the user profile to reflect the set of information sources.
